(19) United States
(12) Patent Application Publication
(10) Pub. No.: US 2020/0320191 A1
(43) Pub. Date: Oct. 8, 2020

(54) INFORMATION PROCESSING APPARATUS

(71) Applicant: Mitsubishi Electric Corporation, Tokyo (JP)

(72) Inventors: Takeshi ASAI, Tokyo (JP); Kiyoto KAWAUCHI, Tokyo (JP)

(73) Assignee: Mitsubishi Electric Corporation, Tokyo (JP)

(21) Appl. No.: 16/464,162

(22) PCT Filed: Jan. 18, 2017
(86) PCT No.: PCT/JP2017/001531

§ 371 Date: May 24, 2019

(51) Int. Cl. G06F 21/55

(52) U.S. Cl. CPC G06F 21/554; G06F 2221/034

(57) ABSTRACT

A measure point extracting unit (203) extracts, from attack route information in which a threat and a plurality of attack routes each including one or more attack actions and being procedures for generating the threat are described, a plurality of combinations of attack actions to be addressed in order to inhibit generation of the threat. An objective-function deriving unit (204) acquires one or more measure candidates and an usability level of each of the measure candidates, for each of the attack actions included in the plurality of combinations of attack actions. The objective-function deriving unit (204) and an objective-function calculating unit (205) generate a plurality of combinations of measure candidates by allocating, for each of the combinations of attack actions, each of measure candidates to each of the attack actions included in the combination of attack actions, calculate, for each of the combinations of measure candidates, an evaluation value, on the basis of the usability level of each of the measure candidates included in the combination of the measure candidates and an importance level of an attack route including an attack action to which each of the measure candidates included in the combination of measure candidates is allocated, and specify a combination of measure candidates to be applied, for each of the combinations of attack actions, on the basis of the evaluation values.

### TECHNICAL FIELD

The present invention relates to an information processing apparatus, an information processing method, and an information processing program.

### BACKGROUND ART

In the technique described in Non Patent Literature 1, a plurality of generation causes (hereinafter, “basic events”) of a threat are extracted using a fault tree (FT). In the technique of Non Patent Literature 1, a paired comparison is performed to each of the extracted basic events to set a priority order among the basic events. Further, security measures (hereinafter, also simply “measures”) are selected for basic events having a high priority rank in the technique of Non Patent Literature 1. Since there are normally a plurality of security measures as candidates, one of the security measures is selected by an AHP (Analytic Hierarchy Process) in the Non Patent Literature 1.

### CITATION LIST

### Non Patent Literature

Non Patent Literature 1: Hirotoshi Omura, Naoshi Sato, “Evaluation of Security Solution by Using Analytic Hierarchy Process”, The 68th National Convention of Information Processing Society of Japan, 4, pp 593-594 (2006).

### SUMMARY OF INVENTION

### Technical Problem

In the technique of Non Patent Literature 1, a measure X is selected for a basic event (hereinafter, “basic event a”) that needs to be preferentially addressed among a plurality of basic events for a threat A. Even if the basic event a is successfully addressed by the measure X, there is a possibility that the threat A is generated due to other basic events. Therefore, measures need to be taken also for other basic events. The basic events and the measures do not correspond in a one-to-one relation and one measure sometimes can be applied to a plurality of basic events. Meanwhile, there are few cases where one measure can be applied to all basic events. Accordingly, a plurality of measures needs to be applied to a plurality of basic events.

However, since measures are selected in the units of basic events in the technique of Non Patent Literature 1, there is a problem that measures cannot be selected for a combination of basic events, that is, a combination of attack actions being generation causes of a threat.

Furthermore, measures are selected without considering attack routes being procedures to a threat in the technique of Non Patent Literature 1. Therefore, the technique of Non Patent Literature 1 has a problem that agile selection of measures corresponding to an actual situation of attacks, such as taking intensive measures on an attack route that has a high possibility of being selected by attackers, cannot be performed.

A main object of the present invention is to solve such problems. More specifically, the present invention aims to enable selection of a combination of most appropriate measure candidates for each of combinations of attack actions that need to be addressed, corresponding to an actual situation of attacks.

### Solution to Problem

An information processing apparatus according to the present invention, includes:
a combination extracting unit to extract, from attack route information in which a threat and a plurality of attack routes each including one or more attack actions and being procedures for generating the threat are described, a plurality of combinations of attack actions to be addressed in order to inhibit generation of the threat;
an acquiring unit to acquire one or more measure candidates and an usability level of each of the measure candidates, for each of the attack actions included in the extracted plurality of combinations of attack actions; and
a specifying unit to generate a plurality of combinations of measure candidates by allocating, for each of the combinations of attack actions, each of measure candidates to each of attack actions included in the combination of attack actions, calculate, for each of the combinations of measure candidates, an evaluation value, on a basis of the usability level of each of the measure candidates included in the combination of measure candidates and an importance level of an attack route including an attack action to which each of the measure candidates included in the combination of measure candidates is allocated, and specify a combination of measure candidates to be applied, for each of the combinations of attack actions, on a basis of the calculated evaluation values.

### Advantageous Effects of Invention

According to the present invention, it is possible to select a combination of most appropriate measure candidates for each of combinations of attack actions that need to be addressed, corresponding to an actual situation of attacks.

### BRIEF DESCRIPTION OF DRAWINGS

FIG. 1 is a diagram illustrating a hardware configuration example of a security measure selection apparatus according to a first embodiment.

FIG. 2 is a diagram illustrating a functional configuration example of the security measure selection apparatus according to the first embodiment.

FIG. 3 is a flowchart illustrating an operation example of the security measure selection apparatus according to the first embodiment.

FIG. 4 is a diagram illustrating an example of a data structure of an attack tree according to the first embodiment.

FIG. 5 is a diagram illustrating a configuration example of a control system according to the first embodiment.

FIG. 6 is a diagram illustrating an example of the attack tree according to the first embodiment.

FIG. 7 is a diagram illustrating a node type, node details, and an attack category No. of a node included in the attack tree according to the first embodiment.

FIG. 8 is a diagram illustrating a node type, node details, and an attack category No. of the node included in the attack tree according to the first embodiment.

FIG. 9 is a diagram illustrating an example of an attack tree according to the first embodiment.

FIG. 10 is a diagram illustrating a node type, node details, and an attack category No. of the node included in the attack tree according to the first embodiment.

FIG. 11 is a flowchart illustrating an example of a procedure of weight calculation of attack goals by an AHP according to the first embodiment.

FIG. 12 is a diagram illustrating an example of a hierarchical structure of an objective, criteria, and candidates according to the first embodiment.

FIG. 13 is a diagram illustrating an example of a correspondence relation between the degree of importance and values according to the first embodiment.

FIG. 14 is a diagram illustrating an example of a paired comparison matrix according to the first embodiment.

FIG. 15 is a diagram illustrating an example of the paired comparison matrix and weights according to the first embodiment.

FIG. 16 is a diagram illustrating an example of weights of attack goals for the objective according to the first embodiment.

FIG. 17 is a diagram illustrating a process of extracting combinations of measure points according to the first embodiment.

FIG. 18 is a diagram illustrating a process of extracting measure candidates according to the first embodiment.

FIG. 19 is a diagram illustrating an example of weights of attack goals, weights of attack routes, attack categories, and detection ratios according to the first embodiment.

FIG. 20 is a diagram illustrating an example of an attack category list according to the first embodiment.

FIG. 21 is a diagram illustrating an example of an attack-goal criterion list, an attack-route criterion list, and a measure criterion list according to the first embodiment.

FIG. 22 is a diagram illustrating an output example of the security measure selection apparatus according to the first embodiment.

FIG. 23 is a diagram illustrating a process of extracting measure candidates according to a second embodiment.

### DESCRIPTION OF EMBODIMENTS

Embodiments of the present invention will be explained below with reference to drawings. In the following descriptions of the embodiments and the drawings, elements denoted by the same reference signs indicate the same or corresponding parts.

### First Embodiment

### Description of Configurations

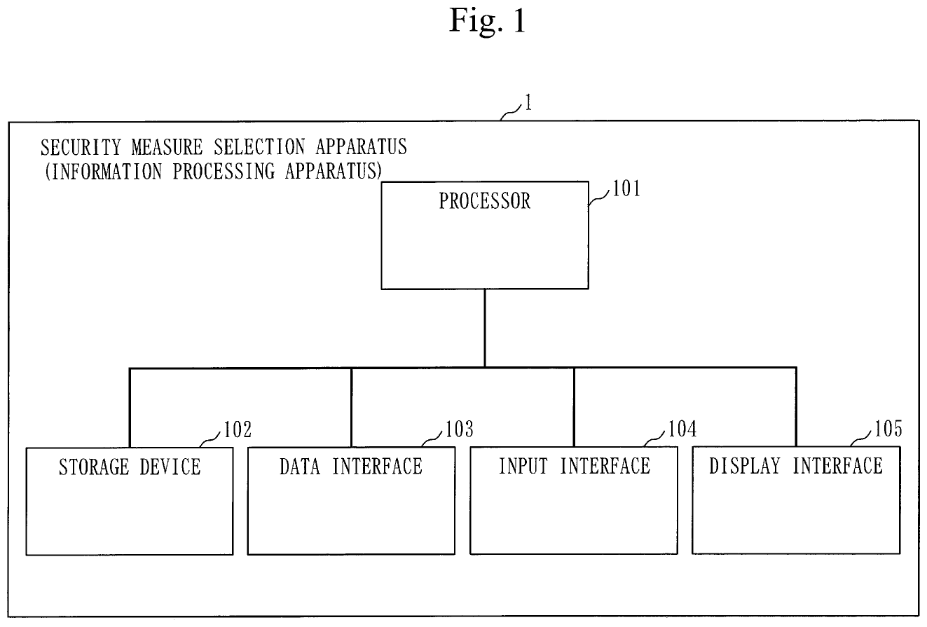

FIG. 1 illustrates a hardware configuration example of a security measure selection apparatus 1 according to the present embodiment.

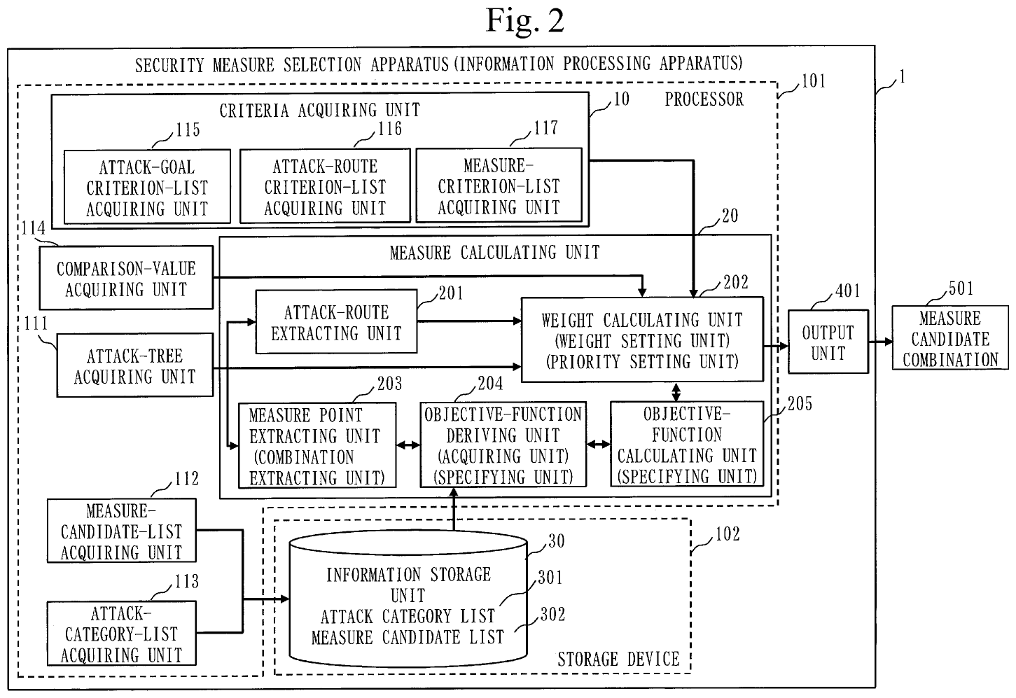

FIG. 2 illustrates a functional configuration example of the security measure selection apparatus 1.

The security measure selection apparatus 1 corresponds to an information processing apparatus. The operation performed by the security measure selection apparatus 1 corresponds to an information processing method and an information processing program.

The security measure selection apparatus 1 is a computer.

As illustrated in FIG. 1, the security measure selection apparatus 1 includes a processor 101, a storage device 102, a data interface 103, an input interface 104, and an display interface 105 as the hardware configuration.

The storage device 102 has stored therein programs that realize functions of a criteria acquiring unit 10, a measure calculating unit 20, an attack-tree acquiring unit 111, a measure-candidate-list acquiring unit 112, an attack-category-list acquiring unit 113, a comparison-value acquiring unit 114, and an output unit 401 illustrated in FIG. 2.

The processor 101 executes these programs to perform operations of the criteria acquiring unit 10, the measure calculating unit 20, the attack-tree acquiring unit 111, the measure-candidate-list acquiring unit 112, the attack-category-list acquiring unit 113, the comparison-value acquiring unit 114, and the output unit 401 described later.

FIG. 2 schematically illustrates a state where the processor 101 is executing the programs that realize the functions of the criteria acquiring unit 10, the measure calculating unit 20, the attack-tree acquiring unit 111, the measure-candidate-list acquiring unit 112, the attack-category-list acquiring unit 113, the comparison-value acquiring unit 114, and the output unit 401.

The data interface 103 is an interface for acquiring data, such as an attack tree described later.

The input interface 104 is an interface for acquiring various instructions from a user of the security measure selection apparatus 1.

The display interface 105 is an interface for outputting display information to a display (not illustrated).

As illustrated in FIG. 2, the security measure selection apparatus 1 includes the criteria acquiring unit 10, the measure calculating unit 20, the attack-tree acquiring unit 111, the measure-candidate-list acquiring unit 112, the attack-category-list acquiring unit 113, the comparison-value acquiring unit 114, and the output unit 401 as the functional configuration.

The attack-tree acquiring unit 111 acquires an attack tree from the data interface 103. The attack-tree acquiring unit 111 outputs the acquired attack tree to an attack-route extracting unit 201, a weight calculating unit 202, and a measure point extracting unit 203.

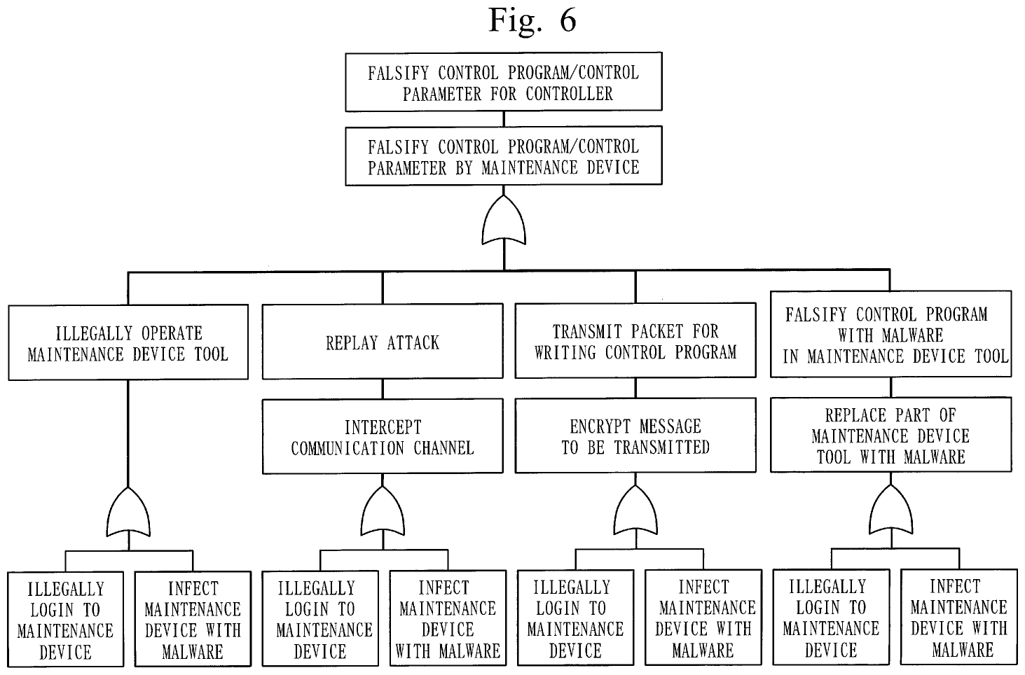

FIG. 6 illustrates an example of the attack tree.

A threat being an objective of an attack is written as an attack goal in the attack tree. In the example of FIG. 6, “falsify a control program/a control parameter for a controller” being a route node is the attack goal. A plurality of attack routes are written in the attack tree. The attack routes are procedures for generating the threat being the attack goal. Each of steps in the procedures is an attack action and therefore each of the attack routes includes one or more attack actions. In the example of FIG. 6, all nodes other than the attack goal (the route node) are attack actions. A chain of nodes from a node on the bottommost layer to the route node is an attack route. For example, a chain of nodes “illegal login to a maintenance device”→“illegally operate a maintenance device tool”→“falsify a control program/a control parameter by a maintenance device”→“falsify a control program/a control parameter for a controller” is one attack route.

The attack tree corresponds to attack route information. Details of the attack tree are described later with reference to FIGS. 6 to 10.

The attack-category-list acquiring unit 113 acquires an attack category list 301 from the data interface 103. The attack-category-list acquiring unit 113 stores the acquired attack category list 301 in an information storage unit 30.

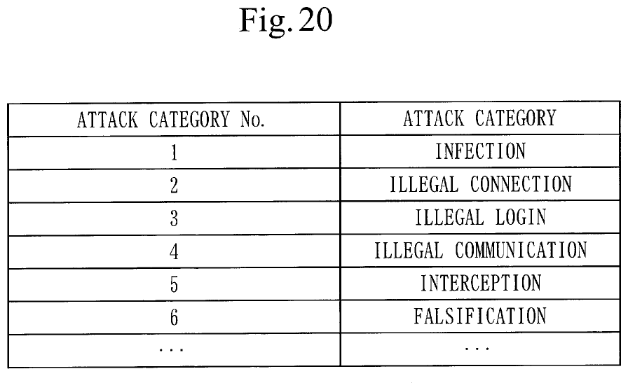

FIG. 20 illustrates an example of the attack category list 301. The attack category list 301 is information that associates attack actions with attack categories as illustrated in FIG. 20.

The measure-candidate-list acquiring unit 112 acquires a measure candidate list 302 from the data interface 103 and stores the acquired measure candidate list 302 in the information storage unit 30.

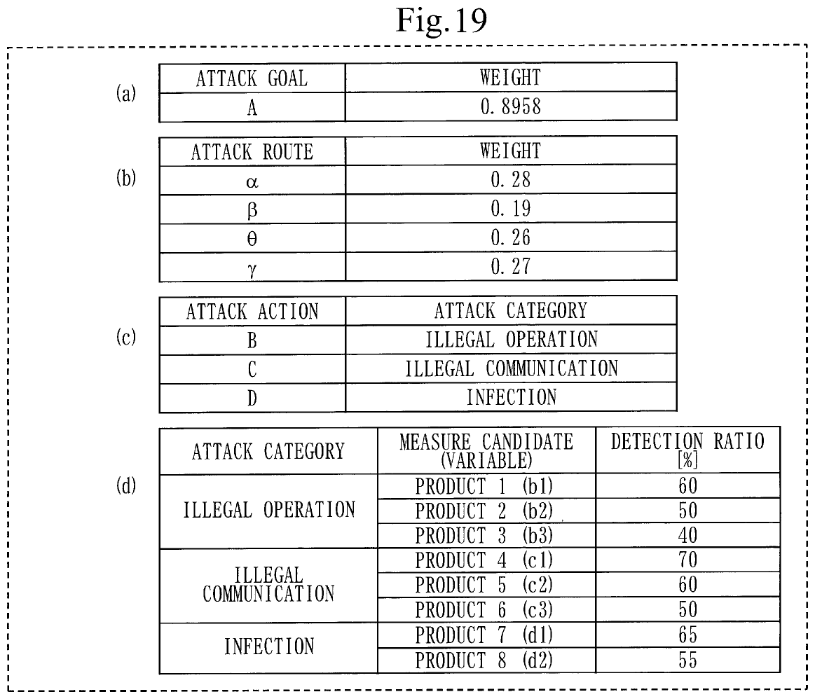

(d) of FIG. 19 illustrates an example of the measure candidate list 302. The measure candidate list 302 is information that associates attack categories with security measure candidates (hereinafter, simply “measure candidates”) and detection ratios of the measure candidates as illustrated in (d) of FIG. 19. A detection ratio is a probability that a measure candidate can detect attack actions. That is, a product 1 in (d) of FIG. 19 detects attack actions of an illegal operation with a probability of 60%. The detection ratio is an index indicating a usability level of the measure candidate.

The comparison-value acquiring unit 114 acquires a comparison value to be used in weight calculation of the weight calculating unit 202 from the data interface 103. The comparison-value acquiring unit 114 outputs the acquired comparison value to the weight calculating unit 202.

The criteria acquiring unit 10 acquires criteria to be used in the weight calculation of the weight calculating unit 202 from the data interface 103. The criteria acquiring unit 10 is configured by an attack-goal criterion-list acquiring unit 115, an attack-route criterion-list acquiring unit 116, and a measure-criterion-list acquiring unit 117.

The attack-goal criterion-list acquiring unit 115 acquires an attack-goal criterion list from the data interface 103. The attack-goal criterion-list acquiring unit 115 outputs the acquired attack-goal criterion list to the weight calculating unit 202.

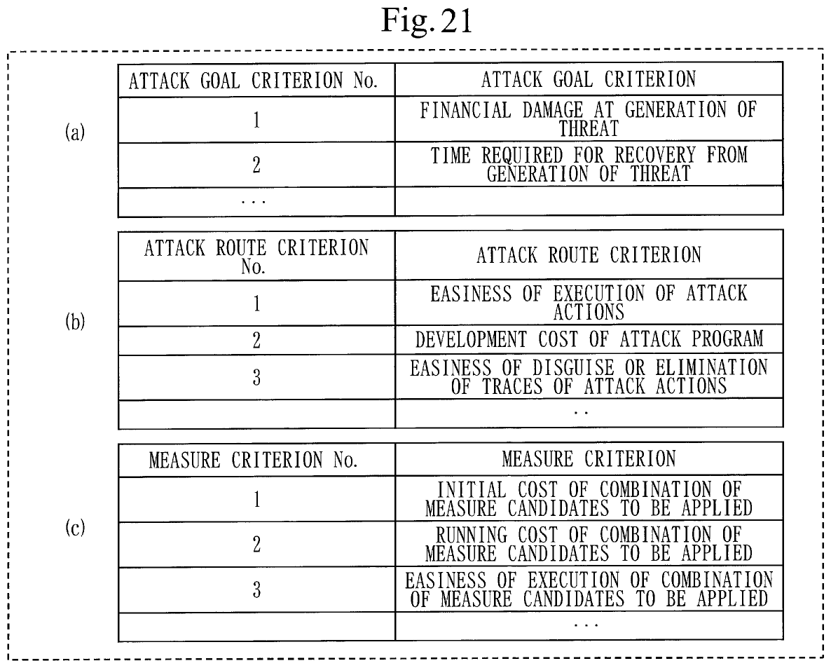

The attack-goal criterion list is information indicating criteria to be referred to by the weight calculating unit 202 when calculating a weight of the attack goal. (a) of FIG. 21 illustrates an example of the attack-goal criterion list.

The attack-route criterion-list acquiring unit 116 acquires an attack-route criterion list form the data interface 103. The attack-route criterion-list acquiring unit 116 outputs the acquired attack-route criterion list to the weight calculating unit 202.

The attack-route criterion list is information indicating criteria to be referred to by the weight calculating unit 202 when the weight calculating unit 202 calculates a weight of an attack route. (b) of FIG. 21 illustrates an example of the attack-route criterion list.

The measure-criterion-list acquiring unit 117 acquires a measure criterion list from the data interface 103. The measure-criterion-list acquiring unit 117 outputs the acquired measure criterion list to the weight calculating unit 202.

The measure criterion list is information indicating criteria to be referred to by the weight calculating unit 202 when the weight calculating unit 202 determines a priority order of a measure point. (c) of FIG. 21 illustrates an example of the measure criterion list.

The measure calculating unit 20 is configured by an attack-route extracting unit 201, the weight calculating unit 202, a measure point extracting unit 203, an objective-function deriving unit 204, and an objective-function calculating unit 205.

The attack-route extracting unit 201 acquires the attack tree from the attack-tree acquiring unit 111. Next, the attack-route extracting unit 201 analyzes the attack tree and extracts a plurality of attack routes from the attack tree. The attack-route extracting unit 201 then notifies the weight calculating unit 202 of the extracted attack routes.

The weight calculating unit 202 acquires the attack tree from the attack-tree acquiring unit 111. Next, the weight calculating unit 202 analyzes the attack tree, calculates a weight for the attack goal, and sets the weight to the attack goal. That is, the weight calculating unit 202 sets the weight to a threat. The weight calculating unit 202 refers to the comparison value output from the comparison-value acquiring unit 114 and the attack-goal criterion list output from the attack-goal criterion-list acquiring unit 115 when calculating the weight for the attack goal.

The weight calculating unit 202 is notified by the attack-route extracting unit 201 of a plurality of attack routes. Next, the weight calculating unit 202 calculates a weight for each of the attack routes as an index indicating the importance level of the attack route, and sets the weight to each of the attack routes. The weight calculating unit 202 refers to the comparison value output from the comparison-value acquiring unit 114 and the attack-route criterion list output from the attack-route criterion-list acquiring unit 116 when calculating the weights for the attack routes.

The weight calculating unit 202 notifies the objective-function deriving unit 204 of the weight of the attack goal and the respective weights of the attack routes.

Further, the weight calculating unit 202 acquires an evaluation value for each of combinations of measure points from the objective-function calculating unit 205. The weight calculating unit 202 sets priorities among the combinations of measure points on the basis of the evaluation values acquired from the objective-function calculating unit 205 and the measure criterion list output from the attack-route criterion-list acquiring unit 116. The weight calculating unit 202 outputs combinations of measure candidates to be applied via the output unit 401 in the descending order of the priority order among the combinations of measure points.

A combination of measure points is a combination of attack actions to be addressed in order to inhibit achievement of the attack goal, that is, generation of the threat.

The weight calculating unit 202 corresponds to a weight setting unit and priority order setting unit.

The measure point extracting unit 203 acquires the attack tree from the attack-tree acquiring unit 111. Next, the measure point extracting unit 203 extracts combinations of measure points from the attack tree. The measure point extracting unit 203 extracts a plurality of combinations of measure points.

The measure point extracting unit 203 corresponds to a combination extracting unit. The operation performed by the measure point extracting unit 203 corresponds to a combination extracting process.

The objective-function deriving unit 204 generates a calculation expression for calculating an evaluation value.

More specifically, the objective-function deriving unit 204 is notified of the weight of the attack goal and the weights of the attack routes from the weight calculating unit 202 and is notified of the combinations of measure points from the measure point extracting unit 203. The objective-function deriving unit 204 also acquires the attack category list 301 and the measure candidate list 302 from the information storage unit 30. The objective-function deriving unit 204 compares attack actions included in the combinations of measure points with the attack category list 301 and specifies attack categories of the attack actions included in the combinations of measure points. Further, the objective-function deriving unit 204 extracts, for each of the attack actions included in the combinations of measure points, one or more measure candidates corresponding to the attack category and the detection ratios of the measure candidates from the measure candidate list 302. The objective-function deriving unit 204 then generates the calculation expression for an evaluation value using the weight of the attack goal, the weights of the attack routes, and the detection ratios of the measure candidates. The objective-function deriving unit 204 notifies the objective-function calculating unit 205 of the generated calculation expression.

The objective-function deriving unit 204 corresponds to an acquiring unit. The objective-function deriving unit 204 corresponds to a specifying unit along with the objective-function calculating unit 205. The operation performed by the objective-function deriving unit 204 corresponds to an acquiring process and a specifying process.

The objective-function calculating unit 205 calculates an evaluation value using the calculation expression notified from the objective-function deriving unit 204.

More specifically, the objective-function calculating unit 205 generates a plurality of combinations of measure candidates for each of the combinations of the measure points by allocating each of measure candidates to each of the attack actions included in the combination of measure points. The objective-function calculating unit 205 then calculates an evaluation value for each of the combinations of measure candidates. More specifically, the objective-function calculating unit 205 calculates the evaluation value on the basis of the weight of the attack goal, the detection ratio of each of the measure candidates included in the combination of measure candidates, and the weight of the attack route including the attack action to which each of the measure candidates included in the combination of measure candidates is allocated. The objective-function calculating unit 205 specifies, for each of the combinations of measure points, a combination of measure candidates to be applied, on the basis of the calculated evaluation values. For example, the objective-function calculating unit 205 specifies, for each of the combinations of measure points, a combination of measure candidates having obtained a highest evaluation value, as the combination of measure candidates to be applied.

The objective-function calculating unit 205 notifies the weight calculating unit 202 of the combination of measure candidates to be applied, for each of the combinations of measure points.

The weight calculating unit 202 sets a priority order among the combinations of measure points on the basis of the evaluation values and the measure criterion list as described above.

The objective-function calculating unit 205 corresponds to the specifying unit along with the objective-function deriving unit 204. The operation performed by the objective-function calculating unit 205 corresponds to the specifying process.

The output unit 401 outputs measure candidate combinations 501.

In the measure candidate combinations 501, for each of the combinations of measure points, a combination of measure candidates to be applied to are indicated in the order determined by the weight calculating unit 202.

The information storage unit 30 stores therein the attack category list 301 and the measure candidate list 302.

The information storage unit 30 is realized by the storage device 102.

### Descriptions of Operations

The operation of the security measure selection apparatus 1 according to the present embodiment is explained next.

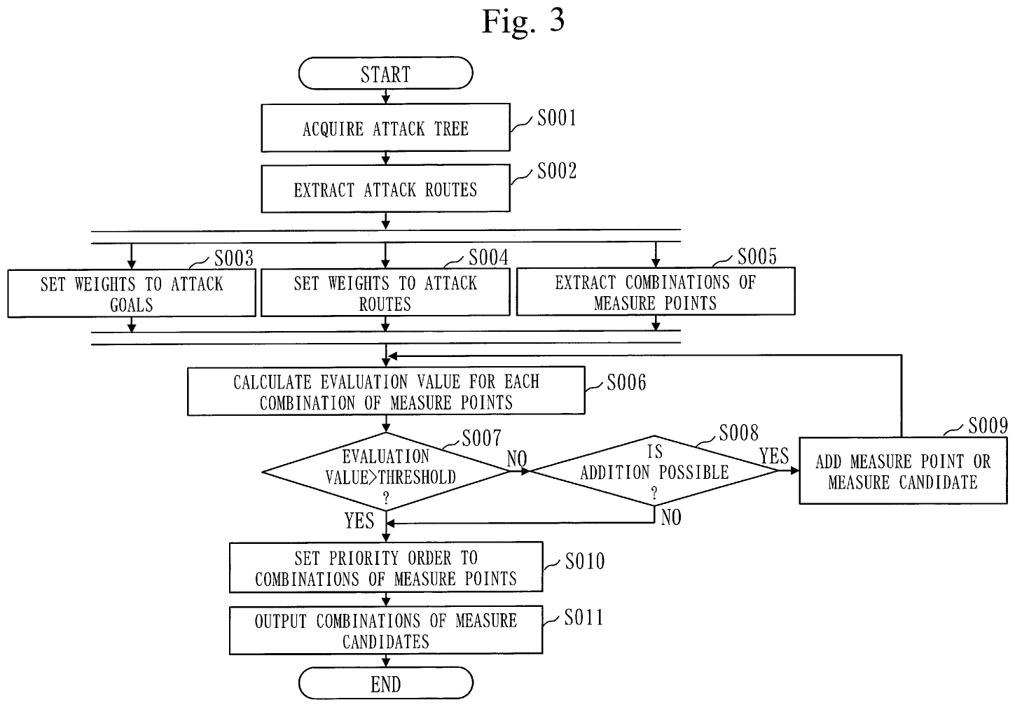

FIG. 3 is a flowchart illustrating an operation example of the security measure selection apparatus 1.

The operation of the security measure selection apparatus 1 is explained below with reference to FIG. 3.

### Step S001

In Step S001, the attack-tree acquiring unit 111 acquires an attack tree.

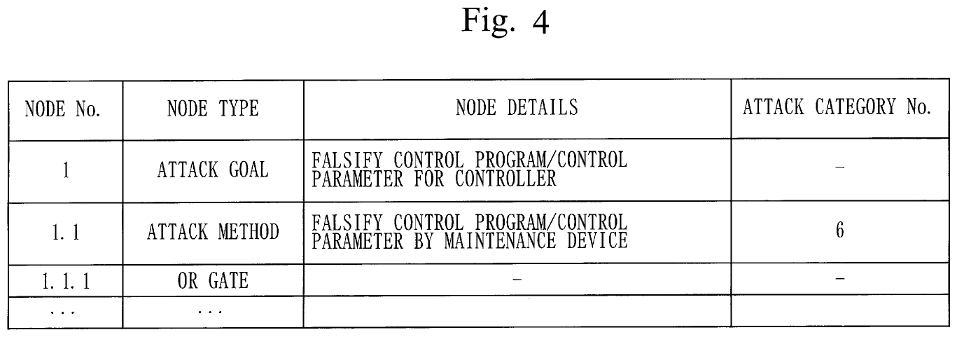

For example, a user of the security measure selection apparatus 1 generates an attack tree and inputs the attack tree to the attack-tree acquiring unit 111. The data format of the attack tree is not limited and the user can generate an attack tree of a data structure illustrated in FIG. 4, for example. In the example in FIG. 4, a “node type”, “node details”, and an “attack category” are associated with “node No.” being an identifier of a node. A node whose “node type” is an “attack goal” is a node representing a threat generated by an attack. A node whose “node type” is an “attack method” is a node representing an attack action that leads to a threat. The “node details” are details of a threat or details of an attack action. The “attack category” is defined only for nodes of the “attack method” and represents the attack form of an attack action. Respective values of “attack category No.” in FIG. 4 are included in “attack category No.” of the attack category list 301.

The user may generate an attack tree of an XML (Extensible Markup Language) data in addition to the data format illustrated in FIG. 4.

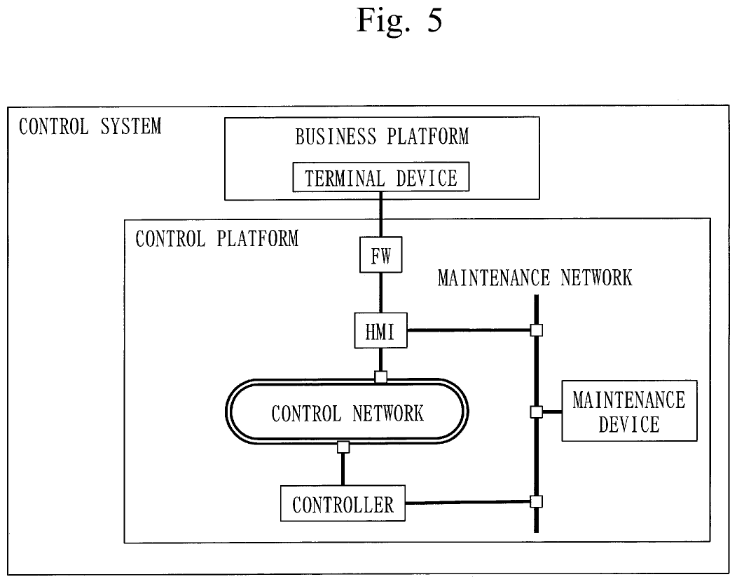

FIG. 5 illustrates a configuration example of a control system. In the present embodiment, an example where the security measure selection apparatus 1 selects security measures for the control system illustrated exemplified in FIG. 5 is explained. The system targeted by the security measure selection apparatus 1 is not limited to the control system.

In FIG. 5, FW denotes Firewall and HMI denotes Human Machine Interface.

FIG. 6 illustrates an attack tree for the control system in FIG. 5. That is, a threat and attack routes illustrated in FIG. 6 are assumed for the control system illustrated in FIG. 5.

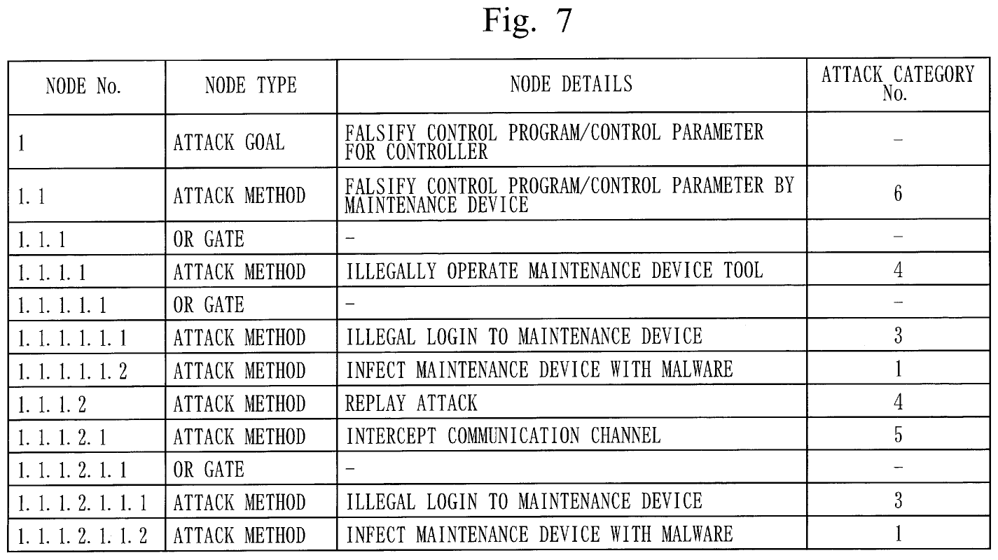

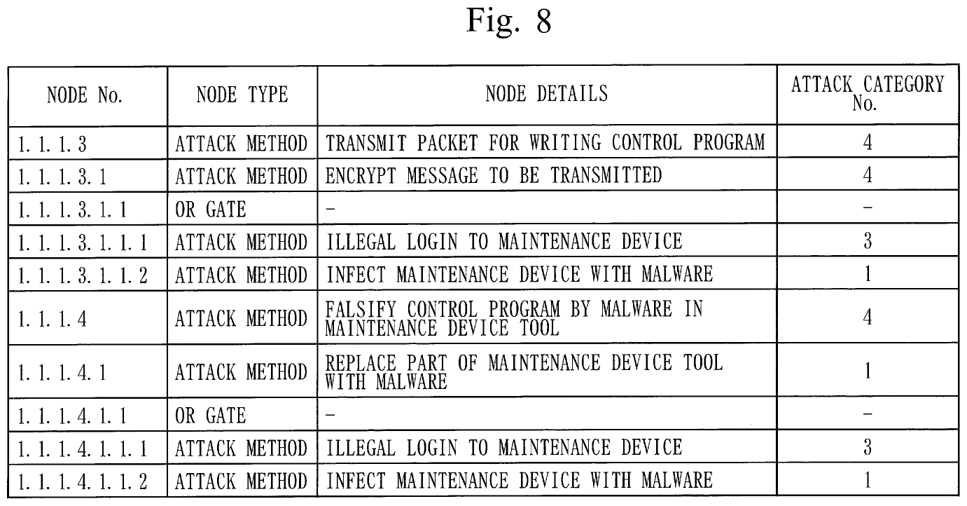

FIGS. 7 and 8 illustrate a data structure of the attack tree illustrated in FIG. 6. That is, the user of the security measure selection apparatus 1 can input the attack tree in FIG. 6 with a data structure in FIGS. 7 and 8 to the attack-tree acquiring unit 111. The user of the security measure selection apparatus 1 specifies the attack No. corresponding to the attack category of each node while referring to the attack category list 301 when inputting the attack tree in FIG. 6 in Step S001. The user sets the specified attack category No. to each node as illustrated in FIGS. 7 and 8.

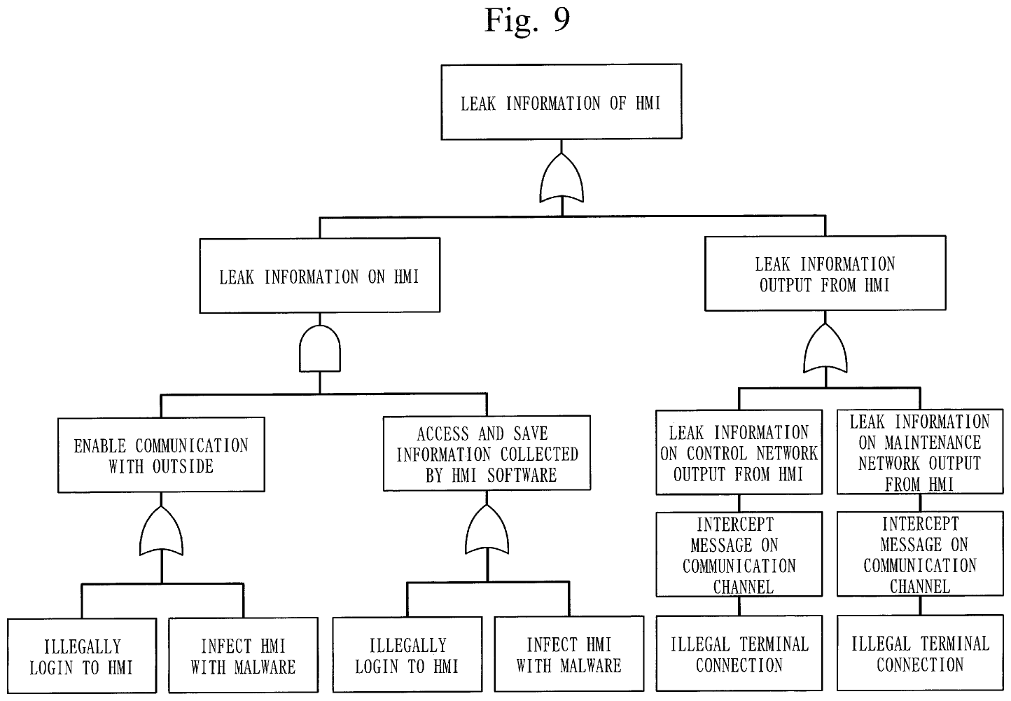

FIG. 9 illustrates an example of an attack tree in which a threat and attack routes different from the threat in FIG. 6 are defined for the control system in FIG. 5. In the attack tree in FIG. 6, a threat “falsify a control program/a control parameter for a controller” is defined. Meanwhile, a threat “leak information of an HMI” is defined in the attack tree in FIG. 9.

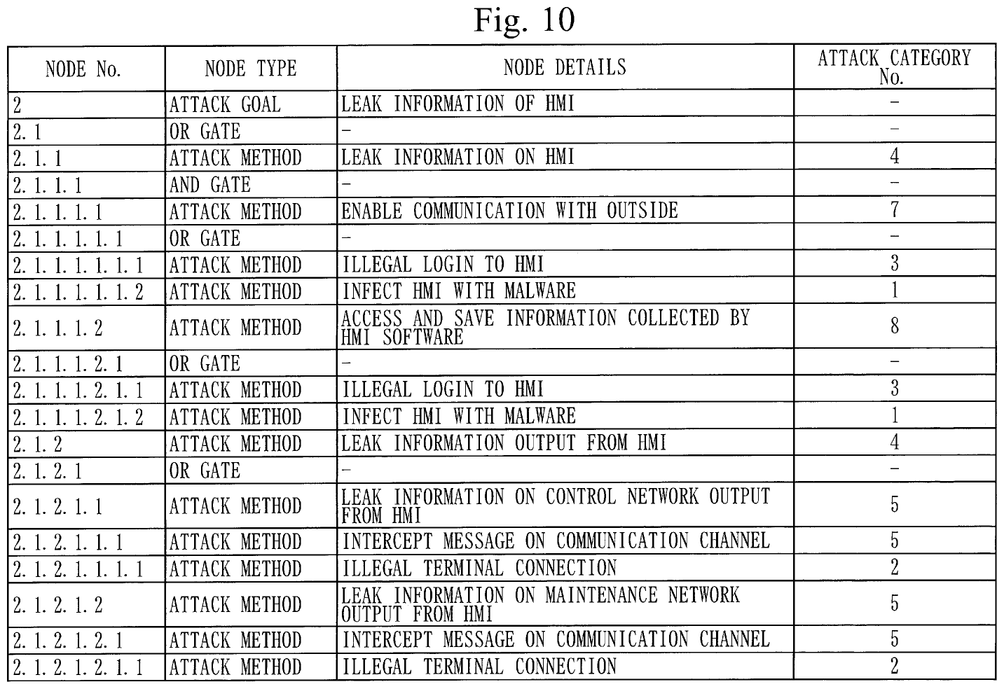

FIG. 10 illustrates a data structure of the attack tree in FIG. 9. That is, the user of the security measure selection apparatus 1 can input the attack tree in FIG. 9 with the data structure in FIG. 10 to the attack-tree acquiring unit 111.

The user may input the attack category list 301 to the attack-category-list acquiring unit 113 before Step S001. The user may alternatively input the attack category list 301 to the attack-category-list acquiring unit 113 in Step S001 along with input of the attack tree to the attack-tree acquiring unit 111. As described above, the attack category list 301 is information exemplified in FIG. 20.

### Step S002

In Step S002, the attack-route extracting unit 201 extracts attack routes from the attack tree acquired by the attack-tree acquiring unit 111. When the attack-tree acquiring unit 111 acquires the attack tree in FIG. 6 and the attack tree in FIG. 9, the attack-route extracting unit 201 extracts a plurality of attack routes from the attack tree in FIG. 6 and a plurality of attack routes from the attack tree in FIG. 9.

An attack route is a set of nodes of all attack methods which have been passed when starting from a root node being the attack goal through lower nodes to a leaf node. The attack-route extracting unit 201 extracts an attack route by tracing nodes from upper nodes to lower nodes as described above. The attack-route extracting unit 201 handles an attack route in a manner as described below when an OR gate or an AND gate is passed in the course tracing from upper nodes to lower nodes.

When an OR gate is passed: all lower attack methods directly connected to the OR gate are handled as different attack routes.

When an AND gate is passed: all lower attack methods directly connected to the AND gate are collectively handled as the same attack route.

The attack routes in the attack tree in FIG. 6 are extracted as follows, using node Nos. in FIGS. 7 and 8, for example.

(1, 1.1, 1.1.1.1, 1.1.1.1.1.1)

(1, 1.1, 1.1.1.1, 1.1.1.1.1.2)

The attack routes in the attack tree in FIG. 9 are extracted as follows, using node Nos. in FIG. 10, for example.

(2, 2.1.1, 2.1.1.1.1, 2.1.1.1.1.1.2, 2.1.1.1.2, 2.1.1.1.2.1.1)

(2, 2.1.1, 2.1.1.1.1, 2.1.1.1.1.1.2, 2.1.1.1.2, 2.1.1.1.2.1.2)

### Step S003

In Step S003, the weight calculating unit 202 sets a weight (a priority order) to the attack goal of the attack tree. While the weight calculating unit 202 sets the weight by the AHP in the present embodiment, the weight setting method is not limited to the AHP. When the attack-tree acquiring unit 111 acquires the attack tree in FIG. 6 and the attack tree in FIG. 8, the weight calculating unit 202 sets a weight to the attack goal of the attack tree in FIG. 6 and sets a weight to the attack goal of the attack tree in FIG. 9.

The AHP is briefly explained below.

The AHP is a problem-solving decision-making method. That is, the AHP is a method in which a decision is made on the basis of both a human subjective judgement and a system approach in an analysis of a problem in decision making More specifically, the AHP is used for an objective such as “selection” or “prioritization”, for example, for “selecting one of a plurality of candidates under a plurality of evaluation criteria” or “determining relative importance levels among a plurality of candidates under a plurality of evaluation criteria”.

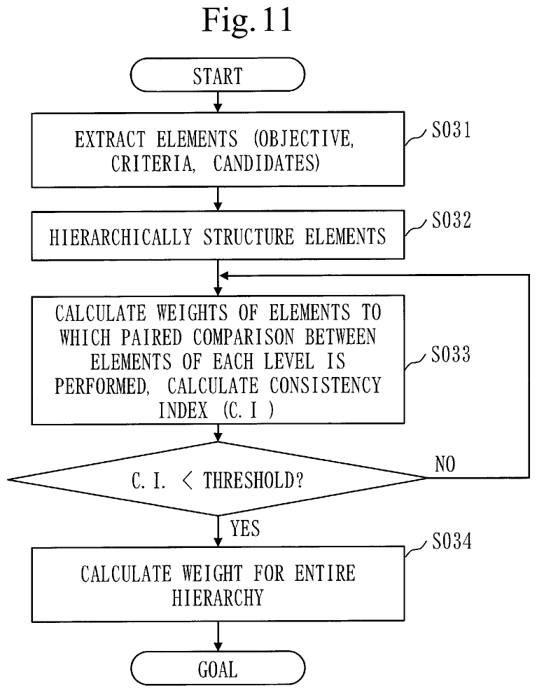

A procedure of prioritization of attack goals by the AHP is illustrated in FIG. 11.

### Step S031

In Step S031, the weight calculating unit 202 extracts elements (an objective, criteria, and candidates) related to a problem.

Since Step S003 in FIG. 3 is a step of prioritizing attack goals, the objective is “prioritizing attack goals requiring measures” and the candidates are attack goals of all attack trees acquired in Step S001. Attack goal criteria of the attack-goal criterion list input by the user to the attack-goal criterion-list acquiring unit 115 are used as the criteria. The attack-goal criterion list is the information illustrated in (a) of FIG. 21 as described above. As illustrated in (a) of FIG. 21, the attack goal criterion is, for example, “financial damage at generation of a threat” or “the time required for recovery from generation of a threat”. The “threat” for the attack goal criterion is a threat indicated in the attack goal.

### Step S032

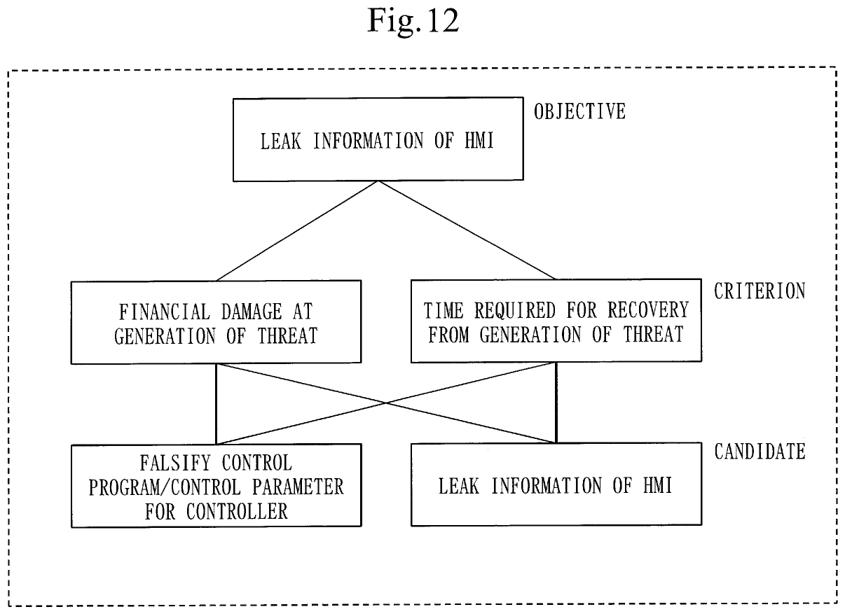

In Step S032, the weight calculating unit 202 hierarchically structures the elements. That is, the weight calculating unit 202 generates a hierarchical structure of the elements extracted in Step S031. The weight calculating unit 202 generates a hierarchical structure in the order of the objective—the criteria—the candidates. An example of the hierarchical structure of the elements extracted in Step S031 is illustrated in FIG. 12. Although both the “financial damage at generation of a threat” and “the time required for recovery from generation of a threat” illustrated in FIG. 12 are directly connected to the objective and are on the same layer, the criteria can be hierarchized according to the specification of the user.

### Step S033

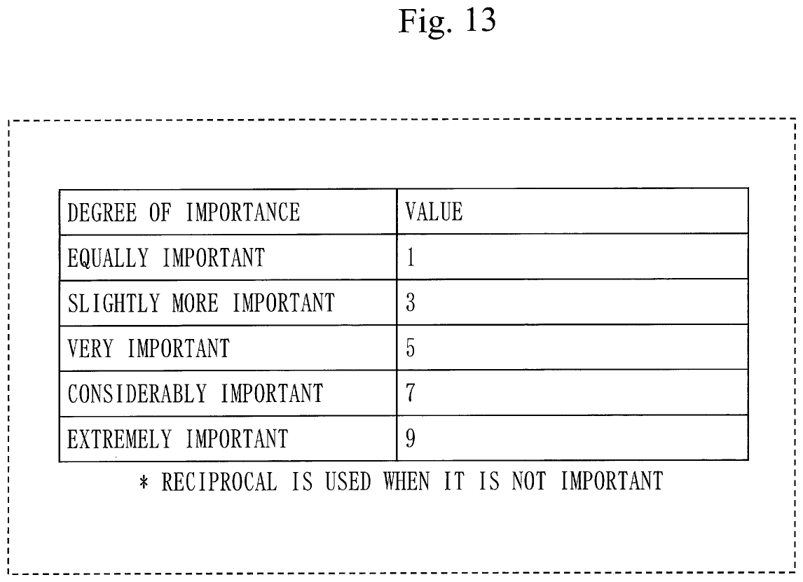

In Step S033, the weight calculating unit 202 performs a paired comparison between elements of the same level under an element on a level just thereabove for each of pairs in the hierarchical structure generated in Step S032. For example, to perform a paired comparison between the criterion “the financial damage at generation of a threat” and the criterion “the time required for recovery from generation of a threat”, the weight calculating unit 202 determines which is more important under the objective “prioritization of attack goals requiring measures”. FIG. 13 illustrates a correspondence relation between the degree of importance and values. The user inputs information illustrated in FIG. 13 to the comparison-value acquiring unit 114. In the paired comparison between “the financial damage at generation of a threat” and “the time required for recovery from generation of a threat”, the comparison is performed once since there are two criteria as elements. However, when there are n elements, the comparison is generally performed n(n−1)/2 times.

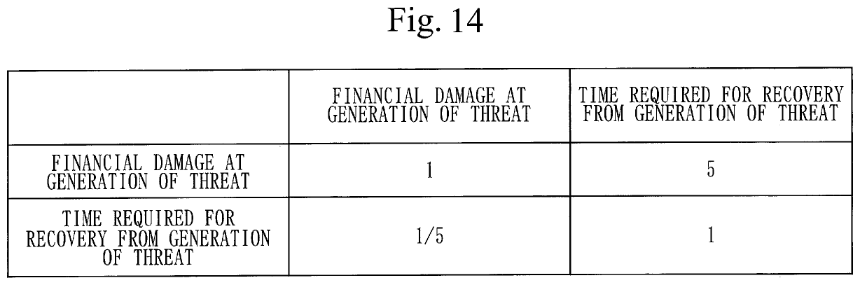

When the weight calculating unit 202 completes all the paired comparisons, a paired comparison matrix as illustrated in FIG. 14 is obtained. The weight calculating unit 202 calculates a maximum eigenvalue of the paired comparison matrix and an eigenvector thereof. The weight calculating unit 202 regards respective values of the eigenvector as weights of elements having compared. The weight calculating unit 202 obtains a consistency index C.I. by calculating (the maximum eigenvalue−n)/(n−1). When C.I. is lower than a previously set threshold, the weight calculating unit 202 determines that a series of values input by the user are consistent. Conversely, when C.I. is above the threshold, the weight calculating unit 202 determines that a series of values input by the user are not consistent and causes the user to input values to the comparison-value acquiring unit 114 again.

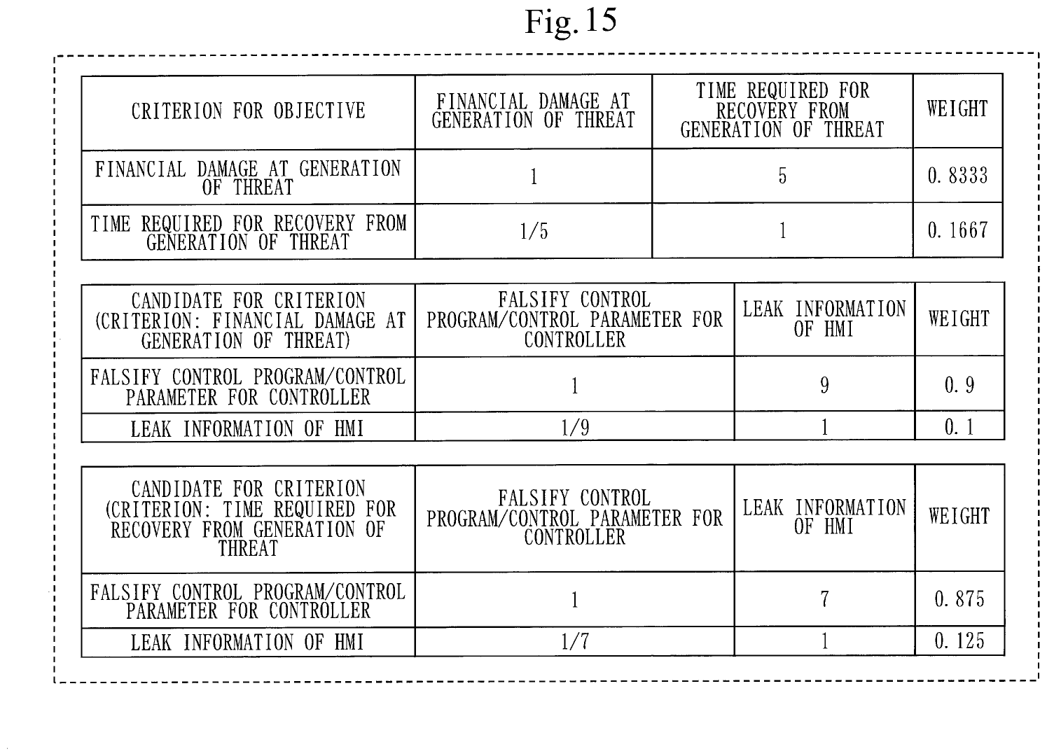

FIG. 15 illustrates criteria for an objective, a paired comparison matrix of candidates for each of the criteria, and weights of respective elements obtained from the paired comparison matrices.

### Step S034

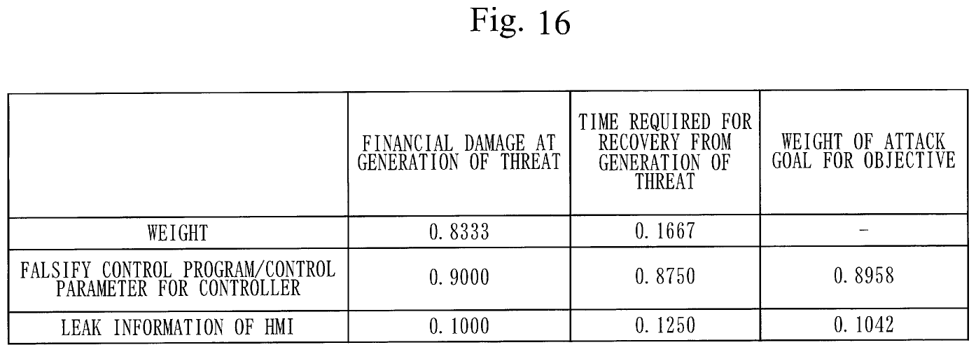

In Step S034, the weight calculating unit 202 calculates a weight of each of candidates for the objective using the weights calculated in Step S032. The weight calculating unit 202 multiplies the weight of a certain criterion for the objective by the weight of a certain candidate for the criterion and takes the sum with respect to all the criteria to obtain the weight of each of the candidates for the objective. FIG. 16 illustrates weights of attack goals for the objective.

### Step S004

Referring back to FIG. 3, the weight calculating unit 202 sets a weight (a priority order) to each of the attack routes extracted in Step S002 for each attack tree in Step S004. Weight setting to the attack routes is performed, for example, by the AHP. The procedure of the weight setting to the attack routes by the AHP is the same as that described in Steps S031 to S034. Therefore, explanations of the procedure of the weight setting to the attack routes by the AHP are omitted.

The weight calculating unit 202 uses the attack-route criterion list input by the user to the attack-route criterion-list acquiring unit 116 for the prioritization of the attack routes. The attack-route criterion list is the information illustrated in (b) of FIG. 21 as described above. As illustrated in (b) of FIG. 21, the attack route criterion is, for example, “easiness of execution of attack actions”, “development cost of an attack program”, or “easiness of disguise or elimination of traces of attack actions”. The “attack actions” written in the attack route criterion are attack actions (nodes of attack methods) included in an attack route as a target for the weight setting. The “attack program” is an attack tool, malware, or the like required to realize the attack actions included in the attack route.

The attack route criterion is a criterion assumed to be examined when an attacker selects an attack route. That is, if it is easy to perform attack actions included in an attack route, an attacker easily selects the attack route. If the development cost of an attack program required for performing the attack actions included in an attack route is low, an attacker easily selects the attack route. If it is easy to perform disguise or elimination of traces of attack actions included in an attack route, an attacker easily select the attack route.

The weight calculating unit 202 calculates the weights of the attack routes using the attack route criteria being selection criteria for an attack route from these viewpoints of an attacker. Accordingly, with utilization of the weights of the attack routes obtained in Step S004 in Step S006 described later, a higher evaluation value is provided to a combination of measure candidates including a measure candidate effective for attack actions included in an attack route easily selected by an attacker. The combination of measure candidates including a measure candidate effective for attack actions included in an attack route easily selected by an attacker is presented to the user.

Examples of the attack routes in the attack trees illustrated in FIGS. 6 and 9 and the weights for the attack routes are described below.

### Attack Tree in FIG. 6

### No.: Attack Route: Weight

(1): (1, 1.1, 1.1.1.1, 1.1.1.1.1.1): 0.126

(2): (1, 1.1, 1.1.1.1, 1.1.1.1.1.2): 0.098

(3): (1, 1.1, 1.1.1.2, 1.1.1.2.1, 1.1.1.2.1.1.1): 0.064

(4): (1, 1.1, 1.1.1.2, 1.1.1.2.1, 1.1.1.2.1.1.2): 0.049

(5): (1, 1.1, 1.1.1.3, 1.1.1.3.1, 1.1.1.3.1.1.1): 0.083

(6): (1, 1.1, 1.1.1.3, 1.1.1.3.1, 1.1.1.3.1.1.2): 0.064

(7): (1, 1.1, 1.1.1.4, 1.1.1.4.1, 1.1.1.4.1.1.1): 0.290

(8): (1, 1.1, 1.1.1.4, 1.1.1.4.1, 1.1.1.4.1.1.2): 0.226

### Attack Tree in FIG. 9

### No.: Attack Route: Weight

(1): (2, 2.1.1, 2.1.1.1.1, 2.1.1.1.1.1.1, 2.1.1.1.2, 2.1.1.1.2.1.1): 0.160

(2): (2, 2.1.1, 2.1.1.1.1, 2.1.1.1.1.1.1, 2.1.1.1.2, 2.1.1.1.2.1.2): 0.171

(3): (2, 2.1.1, 2.1.1.1.1, 2.1.1.1.1.1.2, 2.1.1.1.2, 2.1.1.1.2.1.1): 0.166

(4): (2, 2.1.1, 2.1.1.1.1, 2.1.1.1.1.1.2, 2.1.1.1.2, 2.1.1.1.2.1.2): 0.173

(5): (2, 2.1.2, 2.1.2.1.1, 2.1.2.1.1.1, 2.1.2.1.1.1.1): 0.155

(6): (2, 2.1.2, 2.1.2.1.2, 2.1.2.1.2.1, 2.1.2.1.2.1.1): 0.175

### Step S005

In Step S005, the measure point extracting unit 203 extracts combinations of attack actions to which security measures are to be performed as combinations of measure points from the set of the attack routes extracted from the attack trees in Step S002.

Specifically, the measure point extracting unit 203 represents nodes below the attack goal with a logical expression, for each of the attack trees. At that time, the weight calculating unit 202 handles attack actions connected with an AND gate and attack actions connected with an OR gate in the attack trees in a manner described below. Attack actions connected with an AND gate on the same layer are connected with a “· operation” in the logical expression. Attack actions connected with an OR gate on the same layer are connected with a “+ operation” in the logical expression. For attack actions being in a relation of vertical connection and belonging to different layers, a “· operation” needs to be newly inserted in the logical expression. The reason is that an upper node and a lower node are not equivalent in the attack tree and that the upper node indicates an objective while the lower node indicates a means to achieve the objective. An attacker needs to perform both an attack action of the upper node and an attack action of the lower node in order to achieve the attack goal. Therefore, the measure point extracting unit 203 needs to connect the attack action of the upper node and the attack action of the lower node with a “· operation” in the logical expression.

Next, the measure point extracting unit 203 generates a logical expression of the negative form of the logical expression obtained as described above and converts the logical expression of the negative form into a logical expression in the disjunctive canonical form. Each of terms of the logical expression in the disjunctive canonical form obtained in this manner means prevention of an attack action corresponding thereto. All the terms definitely include in the middle the negation of any attack action in all attack routes that lead to the attack goal. Accordingly, if any of the terms of the logical expression in the disjunctive canonical form is selected and a security measure is performed to the attack action corresponding to the selected term, a threat defined in the attack goal does not occur. Therefore, the measure point extracting unit 203 extracts combinations of terms that prevent achievement of the attack goal, that is, combinations of attack actions to be addressed in order to inhibit generation of a threat defined by the attack goal.

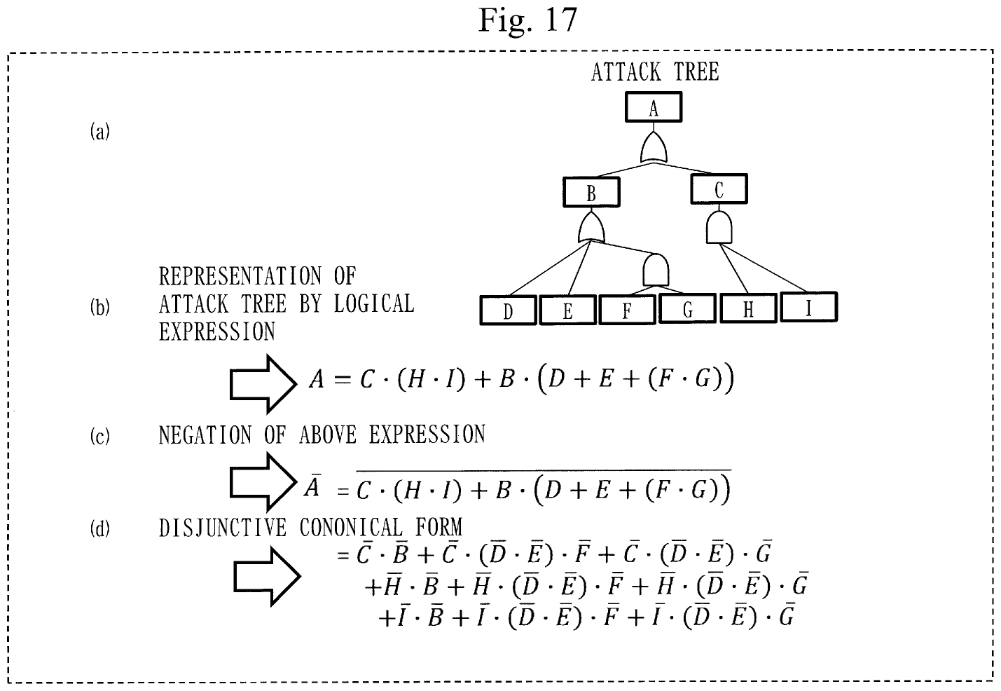

FIG. 17 illustrates an outline of the operation of the measure point extracting unit 203.

Here, an attack tree illustrated in (a) of FIG. 17 is assumed. In the attack tree in (a) of FIG. 17, a node A indicates an attack goal and nodes B to I indicate attack actions.

The attack tree in (a) of FIG. 17 is represented by a logical expression in (b) of FIG. 17. A logical expression in (d) of FIG. 17 is obtained by generating a logical expression of the negative form in (c) of FIG. 17 from the logical expression in (b) of FIG. 17 and converting the logical expression of the negative form to a logical expression of the disjunctive canonical form.

The logical expression in (d) of FIG. 17 has nine terms and therefore the attack tree in (a) of FIG. 17 has nine combinations of measure points, that is, nine combinations of attack actions to be addressed in order to inhibit generation of a threat.

While in the above, explanations have been given in the order of Step S003, Step S004, and Step S005, Step S003, Step S004, and Step S005 have no dependence relation in inputs and outputs thereof and thus Step S003, Step S004, and Step S005 can be performed in any order.

### Step S006

In Step S006, the objective-function deriving unit 204 generates an expression for calculating an evaluation value of a combination of measure points and the objective-function calculating unit 205 calculates an evaluation value for each of the combinations of measure points using the expression.

More specifically, the objective-function deriving unit 204 specifies attack categories of measure points (attack actions) included in the combinations of measure points obtained in Step S005. For example, the objective-function deriving unit 204 specifies the attack categories of the measure points from the attack category Nos. in FIGS. 7, 8, and 10 and the attack category list 301. In this case, it is supposed that attack actions B, C, and D are in attack categories illustrated in (c) of FIG. 19, respectively. The objective-function deriving unit 204 reads the measure candidate list 302 from the information storage unit 30 and extracts measure candidates corresponding to the attack categories of the measure points, referring to the measure candidate list 302. For example, the attack category of the node C in the first term of the logical expression in (d) of FIG. 17 is “illegal communication”. Therefore, the objective-function deriving unit 204 extracts a product 4 (c1), a product 5 (c2), and a product 6 (c3) being measure candidates corresponding to “illegal communication”, referring to the measure candidate list 302 in (d) of FIG. 19. The objective-function deriving unit 204 also extracts 70%, 60%, and 50% each being the detection ratios of these measure candidates. Further, since the attack category of the node B is “illegal operation”, the objective-function deriving unit 204 extracts a product 1 (b1), a product 2 (b2), and a product 3 (b3) being measure candidates corresponding to “illegal operation”. The objective-function deriving unit 204 also extracts 60%, 50%, and 40% being the detection ratios of these measure candidates.

Next, the objective-function deriving unit 204 generates an expression for obtaining the value of the combination of measure candidates as an evaluation value, from the weights of the attack goals obtained in Step S003, the respective weights of the attack routes of each of the attack trees obtained in Step S004, the combinations of measure points obtained in Step S005, the measure candidates for each of the measure points, and the detection ratios thereof. More specifically, the objective-function deriving unit 204 generates an expression in a manner as described below. That is, the objective-function deriving unit 204 generates an expression in which the following operations are performed.

(1) Set a measure candidate corresponding to the attack category of an attack action included in a term of the logical expression as a variable x, and set the detection ratio of the measure candidate set as the variable x as a variable rx. Multiply the variable x by the variable rx and add the multiplication value to a multiplication value between a variable x and a variable rx of another measure candidate.
(2) Multiply the addition value of the above (1) by the sum of the weights of the attack routes to which the attack action included in the term of the logical expression belongs.
(3) Multiply the multiplication value of the above (2) by the sum of the weights of the attack goals of the attack action included in the term of the logical expression.
(4) Repeat (1) to (3) for all the attack actions included in the term of the logical expression to obtain the sum.

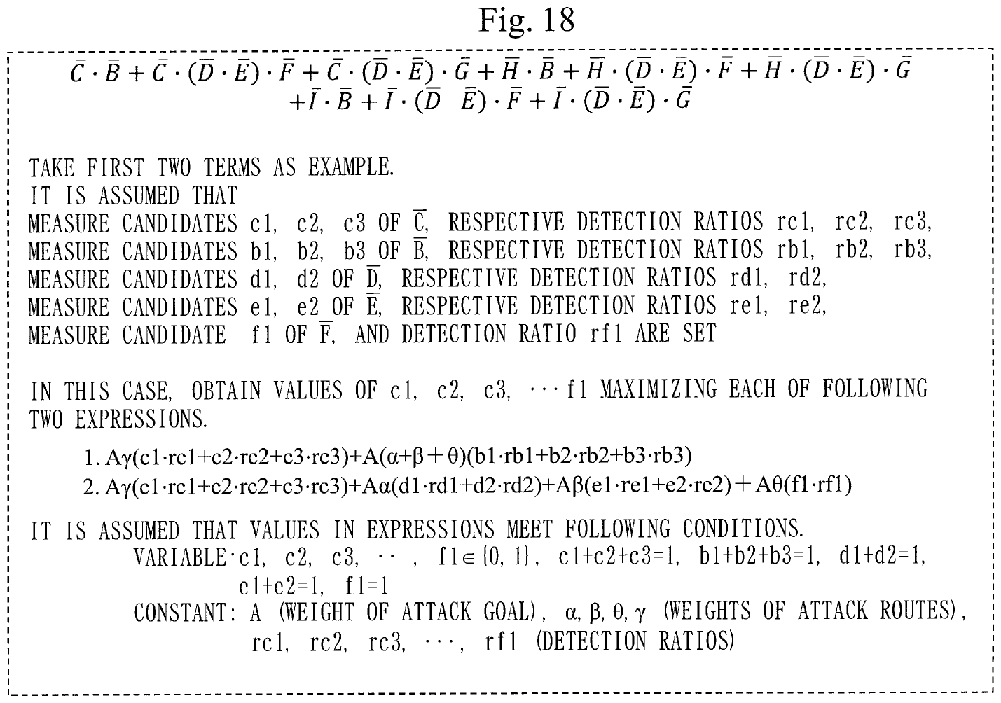

An example of the expression generated by the objective-function deriving unit 204 for the logical expression in (d) of FIG. 17 is illustrated in FIG. 18.

An expression 1 in FIG. 18 is an expression for the first term of the logical expression in (d) of FIG. 17.

That is, in the expression 1, c1, c2, and c3 being measure candidates for the node C are respectively multiplied by rc1, rc2, and rc3 being the respective detection ratios, and obtained three multiplication values (c1·rc1, c2·rc2, c3·rc3) are added. In the expression 1, the addition value (c1·rc1+c2·rc2+c3·rc3) is multiplied by the sum (γ) of the weights of the attack routes and the sum (A) of the weights of the attack goals. Further, in the expression 1, b1, b2, and b3 for the node B are respectively multiplied by the respective detection ratios rb1, rb2, and rb3, and the obtained three multiplication values (b1·rb1, b2·rb2, b3·rb3) are added. In the expression 1, the addition value (b1·rb1+b2·rb2+b3·rb3) is multiplied by the sum (α+β+θ) of the weights of the attack routes and the sum (A) of the weights of the attack goals. Then, “Aγ(c1·rc1+c2·rc2+c3·rc3)” and “A((α+β+θ)b1·rb1+b2·rb2+b3·rb3)” are added. Since the node C is connected to the node H and the node I with an AND gate in the attack tree of (a) in FIG. 17, the node C belongs to one attack route. Therefore, only “γ” is used as the sum of the weights of the attack routes to which the node C belongs. Meanwhile, the node B is connected to the nodes D to G with an OR gate. Further, the node B is connected to the node F and the node G with an AND gate. Therefore, the node B belongs to three attack routes (a route for the node D, a route for the node E, a route for the node F and the node G). Accordingly, the sum of “α”, “β”, and “θ” is used as the sum of the weights of the attack routes to which the node B belongs. Since the node C and the node B are both included only in one attack tree, only “A” is used as the sum of the weights of the attack goals. When a node is included in a plurality of attack trees, the sum of the weights of the attack goals of the attack trees is used.

An expression 2 in FIG. 18 is an expression for the second term of the logical expression in (d) of FIG. 17. Since the expression 2 also has an identical configuration to that of the expression 1, explanations of the expression 2 are omitted.

Although illustrations are omitted in FIG. 18, the objective-function deriving unit 204 generates identical expressions also for the third and subsequent terms in (d) of FIG. 17.

A larger weight is set to an attack goal having a higher importance level. Further, a larger weight is set to an attack route having a higher importance level, in other words, an attack route easily selected by an attacker. With the expressions generated by the objective-function deriving unit 204, an obtained evaluation value is higher as the weight of an attack goal is larger. Further, an obtained evaluation value is higher as the weight of an attack route is larger. An obtained evaluation value is higher as the usability of a measure candidate is higher, that is, as the detection ratio of the measure candidate is higher. Accordingly, the expression generated by the objective-function deriving unit 204 is an expression indicating the effect of the measure candidate. A problem in this case is which measure candidate is to be selected from the combination of measure candidates for each of attack actions to obtain a highest evaluation value. That is, in the example of the expression 1 in FIG. 18, the problem is which measure candidate is to be selected from the measure candidates c1, c2, and c3 for the attack action of the node C and which measure candidate is to be selected from the measure candidates b1, b2, and b2 for the attack action of the node B to obtain a highest evaluation value. The objective-function calculating unit 205 calculates to determine a combination of measure candidates that provides a highest evaluation value.

The operation principle of the objective-function calculating unit 205 is explained below.

The objective-function calculating unit 205 generates a plurality of combinations of measure candidates by combining the measure candidates c1, c2, and c3 and the measure candidates b1, b2, and b3. That is, the objective-function calculating unit 205 generates combinations of c1 and b1, c1 and b2, c1 and b3, c2 and b2, c2 and b2, c2 and b3, c3 and b1, c3 and b2, and c3 and b3. The objective-function calculating unit 205 obtains a combination of c1 and b1 by assigning values to the expression generated by the objective-function deriving unit 204 as c1=1, c2=0, c3=0, b1=1, b2=0, and b3=0. In other combinations, the objective-function calculating unit 205 assigns 1 or 0 to the variables of the respective measure candidates. The objective-function calculating unit 205 then calculates the evaluation values of the respective combinations according to the expression generated by the objective-function deriving unit 204. In the combination of c1 and b1, the evaluation value=0.561 is obtained when the weight of the attack goal, the weights of the attack routes, and the detection ratios of the measure candidates in FIG. 19 are used. The objective-function calculating unit 205 similarly calculates the evaluation values also for other combinations of measure candidates and selects a combination of measure candidates having a highest evaluation value as a combination of measure candidates to be applied to the relevant combination of measure points.

This problem is a 0-1 integer programming problem and therefore the objective-function calculating unit 205 can obtain a combination of measure candidates that maximizes the evaluation value using an existing solver such as a simplex method.

In the first term of the expression in (d) of FIG. 17, the combination of c1 and b1 has the highest evaluation value and the objective-function calculating unit 205 selects c1 and b1 for the first term.

While only the first term in (d) of FIG. 17 has been explained, the objective-function calculating unit 205 also selects a combination of measure candidates for each of the second to ninth terms in an identical procedure.

### Step S007

In Step S007, the objective-function calculating unit 205 determines whether the evaluation value of the combination of measure candidates selected for each of the terms obtained in Step S006 is higher than a threshold. In the example described above, whether the evaluation value of the combination of the measure candidates c1 and b1 selected for the first term of the logical expression in (d) of FIG. 17, that is, 0.561 is higher than the threshold is determined.

When all the evaluation values are higher than the threshold (YES in Step S007), the process proceeds to Step S010. On the other hand, when even one of the evaluation values of the combinations of the measure candidates is equal to or lower than the threshold (NO in Step S007), the process proceeds to Step S008. A term where the evaluation value of the combination of the measure candidates has been determined to be equal to or lower than the threshold correspond to a recalculation combination. The threshold may be previously set in the objective-function calculating unit 205 or may be designated by the user at the phase of Step S007.

### Step S008

In Step S008, the objective-function calculating unit 205 determines whether a measure point or a measure candidate can be added, as for a term where the evaluation value of the combination of measure candidates has been determined to be equal to or lower than the threshold in Step S007.

The objective-function calculating unit 205 determines, for example, whether the negation of a new attack action not included in the term where the evaluation value of the combination of measure candidates has been determined to be equal to or lower than the threshold can be added to the term. The new attack action to be added is limited to an attack action belonging to the same attack route as that of any of attack actions included in the term. Furthermore, it is necessary that a combination of attack actions after addition of the new attack action does not coincide with combinations of attack actions in other terms in the logical expression in the disjunctive canonical form obtained in Step S005. For example, if the evaluation value of the combination of the measure candidates (c1 and b1) for the first term in (d) of FIG. 17 is lower than the threshold, the objective-function calculating unit 205 determines whether there is a node that can be added to the first term among the nodes D to I. In this case, addition of any of the nodes D to Ito the first term does not coincide with the combinations of attack actions in other terms and therefore the objective-function calculating unit 205 determines that addition is possible in Step S008. By performing an addition like this, defense in depth that provides a plurality of measures to one attack route is carried out.

The objective-function calculating unit 205 also determines, for example, whether a measure candidate other than the measure candidates selected in Step S006 can be added to any of the attack actions included in the term where the evaluation value of the combination of the measure candidates has been determined to be equal to or lower than the threshold. For example, if the evaluation value of the combination of the measure candidates (c1 and b1) for the first term in (d) of FIG. 17 is lower than the threshold, the objective-function calculating unit 205 determines whether any of other measure candidates (c2, c3, b2, and b2) can be added to the combination of the measure candidates (c1 and b1) for the first term. When any of the other measure candidates can be added, the objective-function calculating unit 205 determines that the addition is possible in Step S008. A measure candidate to be added is referred to as additional measure candidate.

When it is determined in Step S008 that the addition is possible, the process proceeds to Step S009. On the other hand, when it is determined in Step S008 that the addition is impossible, the process proceeds to Step S010.

### Step S009

In Step S009, the objective-function deriving unit 204 adds a measure point or a measure candidate to the term where the evaluation value of the combination of measure candidates has been determined to be equal to or lower than the threshold.

In a case where a measure point is added, the objective-function deriving unit 204 selects the negation of a new attack action to be added to the term where the evaluation value of the combination of measure candidates has been determined to be equal to or lower than the threshold, and presents the selected negation of the new attack action to the user. When the user approves addition of the negation of the new attack action, the objective-function deriving unit 204 adds the negation of the new attack action to the combination of the measure points for the term. The objective-function calculating unit 205 extracts measure candidates in the manner as described above, for the combination of measure points to which the negation of the new attack action has been added by the objective-function deriving unit 204, calculates the evaluation value for each of combinations of measure candidates, and selects a combination of measure candidates having the highest evaluation value.

In a case where a measure candidate is added, the objective-function deriving unit 204 selects an additional measure candidate to be added to the term where the evaluation value of the combination of measure candidates has been determined to be equal to or lower than the threshold, and presents the selected additional measure candidate to the user. When the user approves addition of the additional measure candidate, the objective-function deriving unit 204 adds the additional measure candidate to the combination of measure candidates for the term. The objective-function calculating unit 205 applies a detection ratio in the manner as described above, to the combination of measure candidates to which the additional measure candidate has been added by the attack-route extracting unit 201, calculates the evaluation value for each of the combinations of measure candidates, and selects a combination of measure candidates having the highest evaluation value.

### Step S010

In Step S010, the weight calculating unit 202 sets a priority order among the combinations of measure points where the evaluation value of the combination of measure candidates has been determined to be higher than the threshold. That is, the weight calculating unit 202 sets a priority order among the combinations of attack actions where the evaluation value of the combination of measure candidates has been determined to be higher than the threshold.

Setting of the priority order is performed, for example, by the AHP. A procedure of setting of the priority order by the AHP is the same as that indicated in Steps S031 to S034. Therefore, explanations of the setting procedure of the priority order by the AHP are omitted.

Since the logical expression in (d) of FIG. 17 has nine terms, nine combinations of measure points (combinations of attack actions) are acquired. The weight calculating unit 202 sets the priority order to the combinations of measure points, for example, on the basis of the evaluation values of the combinations of measure candidates. That is, the objective-function calculating unit 205 sets a higher priority to a combination of measure points having a higher evaluation value. The objective-function calculating unit 205 may set the priority order among the combinations of measure candidates, using the evaluation values and the measure criterion list descried in the measure criterion list. As described above, the measure criterion list is the information illustrated in (c) of FIG. 21. As illustrated in (c) of FIG. 21, the measure criterion is, for example, “initial cost of a combination of measure candidates to be applied”, “running cost of a combination of measure candidates to be applied”, or “easiness of execution of a combination of measure candidates to be applied”. The “easiness of execution” is a criterion whether the combination of measure candidates can be executed even by a person having no knowledge of security.

The use of these measure criteria as criteria for setting the priority order enables selection of a measure considering an acceptable budget or operational load, varies according to operators.

### Step S011

In Step S011, the output unit 401 outputs the combinations of measure candidates according to the priority order set in Step S010.

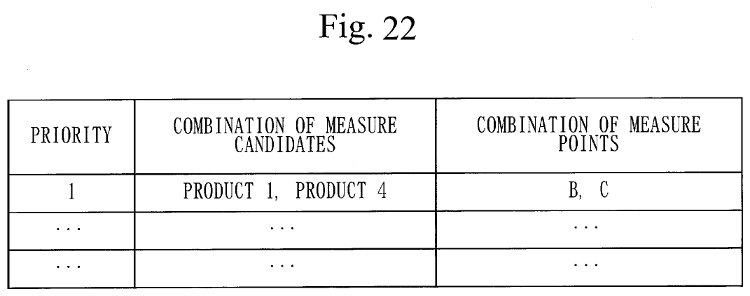

FIG. 22 illustrates an output example (measure candidate combinations 501) of the output unit 401. The output unit 401 displays a combination of measure candidates for a combination of measure points having a higher priority rank on a higher level and displays a combination of measure candidates for a combination of measure points having a lower priority rank on a lower level.

In the example in FIG. 22, the product 1 (the measure candidate b1) and the product 4 (the measure candidate c1) being the combination of measure candidates for the combination of measure points of the first term in (d) of FIG. 17 are displayed on the highest level.

In order to clearly indicate point in the attack tree to which the measure candidates are applied, a column of “combination of measure points” is provided in FIG. 22. However, the column of “combination of measure points” may be omitted.

While the AHP is used in setting of the weights in Steps S003 and S004 and setting of the priority order in Step S010 in the above descriptions, setting of the weights and setting of the priority order can be performed by a method other than the AHP.

In the above descriptions, if there exists even a single combination of measure candidates where the evaluation value is equal to or lower than the threshold in Step S007 (No in Step S007), the process is supposed to proceed to Step S008.

However, if there exist one or more combinations of measure candidates exceeding the threshold, Step S010 may be performed to the combinations of measure candidates exceeding the threshold. That is, even if there exist combinations of measure candidates equal to or lower than the threshold, it is possible to perform the process in Step S010 only to the combinations of measure candidates exceeding the threshold without performing the processes in Step S008 and subsequent steps to the combinations of measure candidates equal to or lower than the threshold.

### Descriptions of Effects of Embodiment

In the present embodiment, the security measure selection apparatus 1 calculates an evaluation value for each of combinations of attack actions to be addressed on the basis of the importance level of a threat, the importance levels of the attack routes, and the usability levels of the measure candidates, and specifies a combination of measure candidates on the basis of the calculated evaluation values. Therefore, according to the present embodiment, agile selection of measures corresponding to an actual situation of attacks, such as implementing measures intensively on an attack route that is easily selected by an attacker, can be performed. Furthermore, according to the present embodiment, a combination of measure candidates can be selected considering the cost to perform measures and the operational load.

### Second Embodiment

In the present embodiment, an example of selecting the most appropriate combination of measure candidates within a budget is explained.

The hardware configuration example and the functional configuration example of the security measure selection apparatus 1 according to the present embodiment are the same as those described in the first embodiment.

The operation of the security measure selection apparatus 1 according to the present embodiment is also the same as that described in the first embodiment, except for matters described below.

The difference from the first embodiment is mainly explained below. Matters not explained below are the same as those in the first embodiment.

In the present embodiment, the cost for introduction is defined for each of measure candidates. Furthermore, in the present embodiment, the objective-function calculating unit 205 maximizes the objective function so that the total value of the costs of a combination of measure candidates does not exceed a budget set by a user.

For example, it is assumed that the measure point extracting unit 203 obtains the logical expression in (d) of FIG. 17 with respect to the attack tree in (a) of FIG. 17.

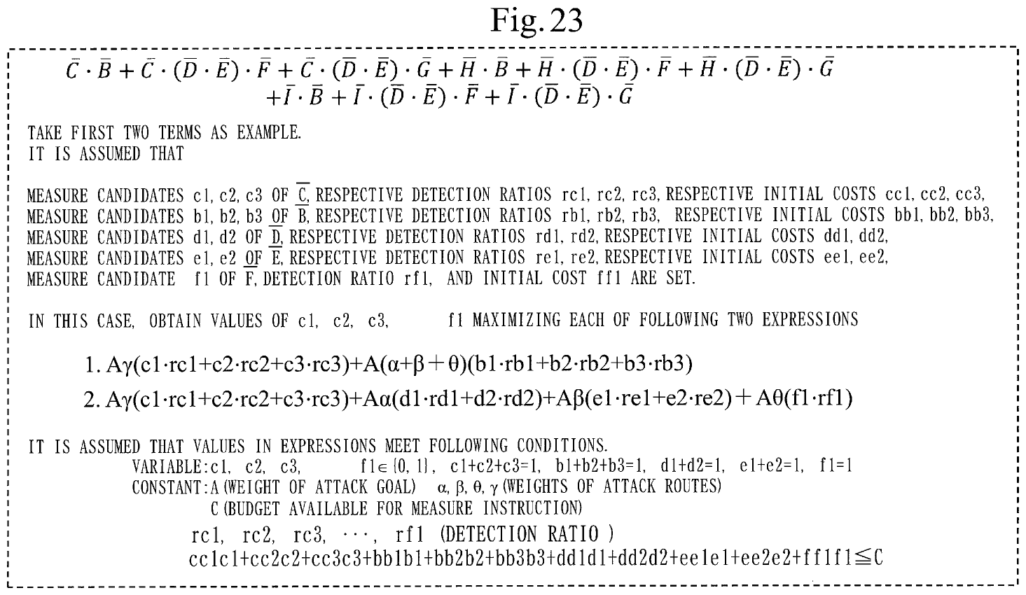

In the present embodiment, it is assumed that the initial cost is defined for each of the measure candidates. It is assumed that initial costs illustrated in FIG. 23 are defined for each of the measure candidates included in the logical expression in (d) of FIG. 17.

Specifically, it is assumed that cc1 is defined as the initial cost for the measure candidate c1. It is assumed that cc2 is defined as the initial cost for the measure candidate c2. It is assumed that cc3 is defined as the initial cost for the measure candidate c3. It is assumed that the initial costs illustrated in FIG. 23 are defined also for the measure candidates b1, b2, b3, d1, d2, e1, e2, and f1.

It is assumed that the objective-function deriving unit 204 derives expressions illustrated in FIG. 23 for the logical expression in (d) of FIG. 17. An expression 1 in FIG. 23 is the same as the expression 1 in FIG. 18 and an expression 2 in FIG. 23 is the same as the expression 2 in FIG. 18.

The objective-function calculating unit 205 calculates the total value of the initial costs for each of the combinations of measure candidates. The objective-function calculating unit 205 selects a combination of measure candidates where the total value of the initial costs is within a budget C that is available for measure introduction and the evaluation value is the highest. Calculation performed by the objective-function calculating unit 205 itself is the same as that described in the first embodiment. The difference from the first embodiment is that the budget C is added as a constraint.

As described above, according to the present embodiment, the most appropriate combination of measure candidates within a budget that is available for measure introduction can be selected.

While the example where the initial costs are defined for each of the measure candidates has been explained above, costs (such as running costs) other than the initial costs can be defined for each of the measure candidates. That is, the objective-function calculating unit 205 can select the most appropriate combination of measure candidates in a range where the total cost including the initial cost and the running cost falls within a budget.

While embodiments of the present invention have been described above, two or more of these embodiments can be carried out by combining them to one another.

Alternatively, one of these embodiments can be partially carried out.

Alternatively, two or more of these embodiments can be carried out by partially combining them to one another.

The present invention is not limited to these embodiments and can be variously modified as necessary.

### Descriptions of Hardware Configuration

Finally, a hardware configuration of the security measure selection apparatus 1 is explained supplementally.

The processor 101 is an IC (Integrated Circuit) that performs processing.

The processor 101 is a CPU (Central Processing Unit), a DSP (Digital Signal Processor), or the like.

The storage device 102 illustrated in FIG. 1 is a RAM (Random Access Memory), a ROM (Read Only Memory), a flash memory, an HDD (Hard Disk Drive), or the like.

Further, an OS (Operating System) is also stored in the storage device 102.

At least a part of the OS is executed by the processor 101.

The processor 101 executes programs that realize functions of the criteria acquiring unit 10, the measure calculating unit 20, the attack-tree acquiring unit 111, the measure-candidate-list acquiring unit 112, the attack-category-list acquiring unit 113, the comparison-value acquiring unit 114, and the output unit 401 while executing at least the part of the OS.

The processor 101 executes the OS, thereby performing task management, memory management, file management, communication control, and the like.

Furthermore, at least any of information, data, signal values, and variable values indicating results of processing by the criteria acquiring unit 10, the measure calculating unit 20, the attack-tree acquiring unit 111, the measure-candidate-list acquiring unit 112, the attack-category-list acquiring unit 113, the comparison-value acquiring unit 114, and the output unit 401 is stored in at least any of the storage device 102, and a register and a cache memory in the processor 101.

Further, the programs for realizing the functions of the criteria acquiring unit 10, the measure calculating unit 20, the attack-tree acquiring unit 111, the measure-candidate-list acquiring unit 112, the attack-category-list acquiring unit 113, the comparison-value acquiring unit 114, and the output unit 401 may be stored in a portable storage medium such as a magnetic disk, a flexible disk, an optical disk, a compact disk, a Blu-ray (registered trademark) disk, and a DVD.

Further, the “unit” of the criteria acquiring unit 10, the measure calculating unit 20, the attack-tree acquiring unit 111, the measure-candidate-list acquiring unit 112, the attack-category-list acquiring unit 113, the comparison-value acquiring unit 114, and the output unit 401 may be replaced with “circuit”, “step”, “procedure”, or “process”.

Further, the security measure selection apparatus 1 may be realized by an electronic circuit such as a logic IC (Integrated Circuit), a GA (Gate Array), an ASIC (Application Specific Integrated Circuit), or an FPGA (Field-Programmable Gate Array).

In this case, the criteria acquiring unit 10, the measure calculating unit 20, the attack-tree acquiring unit 111, the measure-candidate-list acquiring unit 112, the attack-category-list acquiring unit 113, the comparison-value acquiring unit 114, and the output unit 401 are each realized as a part of the electronic circuit.

The processor and the electronic circuit described above are also collectively referred to as “processing circuitry”.

### REFERENCE SIGNS LIST

1: security measure selection apparatus, 10: criteria acquiring unit, 20: measure calculating unit, 30: information storage unit, 101: processor, 102: storage device, 103: data interface, 104: input interface, 105: display interface, 111: attack-tree acquiring unit, 112: measure-candidate-list acquiring unit, 113: attack-category-list acquiring unit, 114: comparison-value acquiring unit, 115: attack-goal criterion-list acquiring unit, 116: attack-route criterion-list acquiring unit, 117: measure-criterion-list acquiring unit, 201: attack-route extracting unit, 202: weight calculating unit, 203: measure point extracting unit, 204: objective-function deriving unit, 205: objective-function calculating unit, 301: attack category list, 302: measure candidate list, 401: output unit, 501: measure candidate combination

1-14. (canceled)

15. An information processing apparatus comprising:
processing circuitry to:
extract, from attack route information in which a threat and a plurality of attack routes each including one or more attack actions and being procedures for generating the threat are described, a plurality of combinations of attack actions to be addressed in order to inhibit generation of the threat;
acquire one or more measure candidates and an usability level of each of the measure candidates, for each of the attack actions included in the extracted plurality of combinations of attack actions;
generate a plurality of combinations of measure candidates by allocating, for each of the combinations of attack actions, each of measure candidates to each of attack actions included in the combination of attack actions, calculate, for each of the combinations of measure candidates, an evaluation value, on a basis of the usability level of each of the measure candidates included in the combination of measure candidates and an importance level of an attack route including an attack action to which each of the measure candidates included in the combination of measure candidates is allocated, and specify a combination of measure candidates to be applied, for each of the combinations of attack actions, on a basis of the calculated evaluation values; and
set a priority order among the combinations of attack actions on a basis of the evaluation values of the combinations of measure candidates to be applied, and output the combinations of measure candidates to be applied in descending order of the priority order among the combinations of attack actions.

16. An information processing apparatus comprising:
processing circuitry to:
extract, from attack route information in which a threat and a plurality of attack routes each including one or more attack actions and being procedures for generating the threat are described, a plurality of combinations of attack actions to be addressed in order to inhibit generation of the threat;
acquire one or more measure candidates and an usability level of each of the measure candidates, for each of the attack actions included in the extracted plurality of combinations of attack actions;
generate a plurality of combinations of measure candidates by allocating, for each of the combinations of attack actions, each of measure candidates to each of attack actions included in the combination of attack actions, calculate, for each of the combinations of measure candidates, an evaluation value, on a basis of the usability level of each of the measure candidates included in the combination of measure candidates and an importance level of an attack route including an attack action to which each of the measure candidates included in the combination of measure candidates is allocated, and specify a combination of measure candidates to be applied, for each of the combinations of attack actions, on a basis of the calculated evaluation values; and
set a weight to each of the attack routes as the importance level of each of the attack routes;
wherein the processing circuitry acquires detection ratios of attack actions as the usability levels of measure candidates, and
calculates the evaluation value, for each of combinations of measure candidates, on a basis of the detection ratio of each of the measure candidates included in the combination of measure candidates and the weight of the attack route including the attack action to which each of the measure candidates included in the combination of measure candidates is allocated.

17. The information processing apparatus according to claim 15,
wherein the processing circuitry
sets the priority order among combinations of attack actions where the evaluation value of a combination of measure candidates to be applied is higher than a threshold.

18. The information processing apparatus according to claim 16,
wherein the processing circuitry
sets a weight to each of a plurality of threats described in a plurality of pieces of attack route information,
sets a weight to each of a plurality of attack routes described in the plurality of pieces of attack route information, as the importance level of each of the attack routes,
extracts a plurality of combinations of attack actions from the plurality of pieces of attack route information, and
calculates an evaluation value, for each of the combinations of measure candidates, on a basis of the weight of a threat described in attack route information being an extraction source of each of the combination of attack actions, the detection ratio of each of the measure candidates included in the combination of measure candidates, and the weight of attack route including attack action to which each of the measure candidates included in the combination of measure candidates is allocated.

19. An information processing apparatus comprising:
processing circuitry to:
extract, from attack route information in which a threat and a plurality of attack routes each including one or more attack actions and being procedures for generating the threat are described, a plurality of combinations of attack actions to be addressed in order to inhibit generation of the threat;
acquire one or more measure candidates and an usability level of each of the measure candidates, for each of the attack actions included in the extracted plurality of combinations of attack actions; and
generate a plurality of combinations of measure candidates by allocating, for each of the combinations of attack actions, each of measure candidates to each of attack actions included in the combination of attack actions, calculate, for each of the combinations of measure candidates, an evaluation value, on a basis of the usability level of each of the measure candidates included in the combination of measure candidates and an importance level of an attack route including an attack action to which each of the measure candidates included in the combination of measure candidates is allocated, and specify a combination of measure candidates to be applied, for each of the combinations of attack actions, on a basis of the calculated evaluation values;
wherein the processing circuitry adds, to a recalculation combination being a combination of attack actions where the evaluation value of the combination of measure candidates to be applied is equal to or lower than a threshold among the combinations of attack actions, a new attack action not included in the recalculation combination but belonging to a same attack route as that of any of attack actions included in the recalculation combination, generates a plurality of combinations of measure candidates by allocating a measure candidate to each of attack actions included in the recalculation combination after the new attack action is added, calculates, for each of the combinations of measure candidates, an evaluation value, on a basis of the usability level of each of the measure candidates included in the combination of measure candidates and the importance level of attack route including the attack action to which each of the measure candidates included in the combination of measure candidates is allocated, and specifies a combination of measure candidates to be applied to the recalculation combination after the new attack action is added, on a basis of the calculated evaluation values.

20. The information processing apparatus according to claim 15,
wherein the processing circuitry
specifies, for any of attack actions included in a recalculation combination being a combination of attack actions where the evaluation value of the combination of measure candidates to be applied is equal to or lower than a threshold among the combinations of attack actions, a measure candidate other than the measure candidates to be applied as an additional measure candidate and
calculates an evaluation value of the recalculation combination after the additional measure candidate is specified, on a basis of the usability levels of measure candidates to be applied and the usability level of the additional measure candidate.

21. The information processing apparatus according to claim 16,
wherein the processing circuitry
specifies, for any of attack actions included in a recalculation combination being a combination of attack actions where the evaluation value of the combination of measure candidates to be applied is equal to or lower than a threshold among the combinations of attack actions, a measure candidate other than the measure candidates to be applied as an additional measure candidate and
calculates an evaluation value of the recalculation combination after the additional measure candidate is specified, on a basis of the usability levels of measure candidates to be applied and the usability level of the additional measure candidate.

22. The information processing apparatus according to claim 19,
wherein the processing circuitry
specifies, for any of attack actions included in a recalculation combination being a combination of attack actions where the evaluation value of the combination of measure candidates to be applied is equal to or lower than a threshold among the combinations of attack actions, a measure candidate other than the measure candidates to be applied as an additional measure candidate and
calculates an evaluation value of the recalculation combination after the additional measure candidate is specified, on a basis of the usability levels of measure candidates to be applied and the usability level of the additional measure candidate.

23. The information processing apparatus according to claim 16,
wherein the processing circuitry
calculates a weight for each of the attack routes, using at least any of easiness of execution of the attack actions included in the attack route, a development cost of an attack program for the attack actions included in the attack route, and easiness of disguise or elimination of traces of the attack actions included in the attack route as a parameter, and sets the weight obtained by calculation to the attack route.

24. The information processing apparatus according to claim 18,
wherein the processing circuitry
calculates a weight for each of threats, using at least either financial damage at generation of the threat or time required for recovery from generation of the threat as a parameter, and sets the weight obtained by calculation to the threat.

25. The information processing apparatus according to claim 15,
wherein the processing circuitry
sets the priority order among the combinations of attack actions, on a basis of at least any of an initial cost of the combination of measure candidates to be applied, a running cost of the combination of measure candidates to be applied, and easiness of execution of the combination of measure candidates to be applied, and the evaluation value of the combination of measure candidates to be applied.

26. The information processing apparatus according to claim 15,
wherein the processing circuitry
specifies, for each of the combinations of attack actions, a combination of measure candidates having obtained a highest evaluation value as the combination of measure candidates to be applied.

27. The information processing apparatus according to claim 16,
wherein the processing circuitry
specifies, for each of the combinations of attack actions, a combination of measure candidates having obtained a highest evaluation value as the combination of measure candidates to be applied.

28. The information processing apparatus according to claim 19,
wherein the processing circuitry
specifies, for each of the combinations of attack actions, a combination of measure candidates having obtained a highest evaluation value as the combination of measure candidates to be applied.

29. The information processing apparatus according to claim 15,
wherein a cost for introduction is defined for each of the measure candidates, and
the processing circuitry
calculates a total value of costs, for each of the combinations of measure candidates, and
specifies, for each of the combinations of attack actions, a combination of measure candidates where a total value of costs is within a budget available for measure introduction and a highest evaluation value has been obtained as the combination of measure candidates to be applied.

30. The information processing apparatus according to claim 16,
wherein a cost for introduction is defined for each of the measure candidates, and
the processing circuitry
calculates a total value of costs, for each of the combinations of measure candidates, and
specifies, for each of the combinations of attack actions, a combination of measure candidates where a total value of costs is within a budget available for measure introduction and a highest evaluation value has been obtained as the combination of measure candidates to be applied.

31. The information processing apparatus according to claim 19,
wherein a cost for introduction is defined for each of the measure candidates, and
the processing circuitry
calculates a total value of costs, for each of the combinations of measure candidates, and
specifies, for each of the combinations of attack actions, a combination of measure candidates where a total value of costs is within a budget available for measure introduction and a highest evaluation value has been obtained as the combination of measure candidates to be applied.
